(19) United States
(12) Patent Application Publication
(10) Pub. No.: US 2014/0304646 A1
(43) Pub. Date: Oct. 9, 2014

(54) SLIDING SIDE MENU GUI WITH MENU ITEMS DISPLAYING INDICIA OF UPDATED CONTENT

(71) Applicant: Alain Rossmann, Palo Alto, CA (US)

(72) Inventor: Alain Rossmann, Palo Alto, CA (US)

(73) Assignee: KLIP, INC., Palo Alto, CA (US)

(21) Appl. No.: 13/856,765

(22) Filed: Apr. 4, 2013

(51) Int. Cl. G06F 3/0482

(52) U.S. Cl. CPC G06F 3/0482
USPC 715/790

(57) ABSTRACT

A sliding side menu GUI interface for computerized devices that shows indicia of updated content on at least some of its various menu items. These indicia can include icons representing graphics or thumbnail images representing individuals that caused the updated content, type of updated content, amount of updated content, or other useful information. This enables the user, while operating an original application screen, while still retaining the original screen in short term human memory, to quickly call up the sliding side menu, look for indicia of updated content or interesting new content, and if there is no such content return to the original screen without significant human short term memory loss of the original screen. The method may be implemented by server software, device software, or combination of server and device software. The method is well suited for small touchscreen devices such as smartphones and tablets.

### BACKGROUND OF THE INVENTION

1. Field of the Invention

This invention is in the field of graphical user interfaces (GUI) for computerized devices. More specifically, the invention is related to methods of selectively displaying sliding side menus for touchscreen computerized devices such as tablets and smartphones with limited display screen area.

2. Description of the Related Art

Within roughly the last year prior to the filing date of this application, “drawers” type menus have become popular for touchscreen type computerized devices such as smartphones and tablet computers. Such drawers type menus, which are more formally described as “sliding side menus”, or in slang also occasionally referred to as “hamburger menu drawers” or “hamburger sidebars”, or “sliding menus”, are presently used by a number of smartphone apps (software applications) produced by Google Inc., Mountain View, Calif. and Facebook, Inc., Menlo Park, Calif. On the popular Apple iOS series of smartphones (e.g. Apple iPhone 4 and 5), apps that include sliding side menus include YouTube and Google+ produced by Google Inc., and the Facebook app produced by Facebook, Inc., and others.

Although most popular on touchscreen systems with limited display areas, such as smartphones and tablet computers, sliding side menus are also presently available for various websites, such as YouTube.com, that running under standard computer web browsers, such as Google Chrome. These web browser type sliding side screens are capable of being operated and displayed on conventional, large screen, non-touch monitors, such as Windows 7 and 8 desktop computer systems operated by conventional mouse type pointing devices.

In Android operating system type smartphones and tablets, other apps that may use sliding side menus may include apps such as Foursquare, Rdio, Plume, VLC for Android, ESPN ScoreCenter, Wunderlist 2, The Verge, MTG Familiar, Mantano Reader, Falcon Pro (Beta), and MW3 Barracks.

An Android library that allows users to incorporate sliding menus into their various Android applications has been provided by Jeremy Feinstein, copyright 2012, and has been made publically available at github.com. Examples of these applications were also posted on YouTube as Android SlidingMenu Demo on Jun. 10, 2012, and AndroidSlidingMenu Update 2 on Jul. 5, 2012.

Although such sliding side menus have some useful advantages, particularly for small touchscreen type computerized devices, further advances in this field would be useful.

### BRIEF SUMMARY OF THE INVENTION

The invention is based, in part, on the observation that although the various sliding side menus produced to date have useful advantages from the user interface perspective, additional improvements would add more to the utility of this type of GUI element.

Because sliding side menus often operate by gradually extending from the side of the computerized device display (usually upon user touch or click on an activation icon, swipe, or other mechanism), this gradual side menu extension helps the human user, who must hold short-term memories in a relatively small human working memory, remember the original context of the screen (e.g. original screen) from which the menu was first called. The user can then use the sliding side menu to perform various commands, and then cause the menu to gradually retract, thus returning the user to the original screen context. This method avoids taxing the user's limited short term human memory.

Often, users activate a sliding side menu with the thought of jumping to a related screen or page that might potentially have content that was updated since the last time the user visited that related screen or page. If, however, the user then uses the sliding side menu to jump to the related screen or page, and there is in fact no updated content, then the user has, in his or her limited human short term memory, thus lost much of the context of the original screen for no good reason.

The invention is further based, in part, on the insight this problem of unnecessary human short term memory depletion could be minimized by using an improved sliding side screen menu that informs the user when various related screens on the menu have updated content.

That if an improved sliding side menu could be provided which also has indicia (e.g. visible text, thumbnail images or icons, symbols and the like) of updated content, then the user would be able to quickly look at the sliding side menu and see if using the menu to jump to another screen or page was warranted or not. If, for example, the sliding side menu indicia showed that there was no updated content, or no updated content of present interest to the user, then the user could easily return to the original screen without losing track of the context of the original screen. This would significantly reduce the demand on the user's limited human short-term memory.

Thus in one embodiment, the invention may be a system and method for providing one or more sliding side menu GUI interfaces for computerized devices. The invention may provide indicia of updated content on at least some of the various sliding side menu items (e.g. items listed on the menu). These indicia can, for example, include icons such as graphics or thumbnail images that can represent the individual or organizations that caused the updated content (if any), as well as icons representing the type of updated content, amount of updated content, or other useful information pertaining to any updated content.

Here, to cause the updated content, the individual or organization might be involved in various ways. The individual or organization might provide the updated content, or alternatively the updated content might pertain to some other event with regards to the individual or organization, which might be reported on by other individuals, organizations, or devices. Thus, for example, a celebrity might directly provide content, and be represented by a thumbnail image of the celebrities face, or alternatively something might happen to the celebrity, and this might be reported with updated content, reported by third parties, that is also represented by an icon of the celebrity's face. Indeed a computerized device might automatically send out reminders pertaining to the celebrity that also would be represented by an icon of the celebrity's face.

Thus the “cause” can be any updated content that, but for the existence of the individual or organization, that particular updated content would not have occurred. Thus the individual can “cause” the updated content by directly providing the updated content, or “cause” the updated content by many other ways as well, such as being affected by some event in a manner that is then reported by the updated content.

Thus the invention enables the user, while operating an original application screen or other software screen or webpage, to (while still retaining the original screen in short term human memory) quickly call up a sliding side menu, look for indicia of updated content or interesting new content, and if there is no such content, return to the original screen without significant human short term memory loss of the original screen.

The method may be implemented by server software, device software, or a combination of server and device software. The method is well suited for small touchscreen devices such as smartphones and tablets.

### BRIEF DESCRIPTION OF THE DRAWINGS

FIG. 1 shows an overview of how the invention's software implemented methods, here shown operating on an internet server (or other computer server) and various computerized devices, can assemble indicia of updated content and links to updated content on the server, transmit these indicia and links to various computerized devices, where these indicia and links may then be displayed in the form of various sliding side menus.

FIG. 2 shows an example of the invention's improved sliding side menu in operation. Here on the left, the user is first viewing an app page showing various messages, announcements, and video clips as these arrive in order. In the middle, the user has invoked the sliding side menu, and this is shown partially extended. On the right, the sliding side menu has fully extended, and now covers most of the original app page. This sliding side menu shows various menu items, at least some of which are linked to indicia (here small icons) showing various types of updated content. Indeed in this example, some of the most recently updated content, also seen on the original app screen on the left, is also reflected in some of the sliding side menu indicia icons.

FIG. 3 shows a larger view of the original app page, showing updates from various individuals that the app user is following, and a system update as well, all received within the last few minutes.

FIG. 4 shows a larger view of the invention's improved sliding side menu, here shown fully extended. In this example, only a small stub of the original app page is still visible.

FIG. 5 shows how, in this example at least some of the recent messages, announcements, and updates on the app page also have corresponding indicia and links on the sliding side menu.

### DETAILED DESCRIPTION OF THE INVENTION

In one embodiment, the invention may be software implemented method or system for displaying indicia (e.g. images, icons, text) representing updated content in at least one sliding side menu, such as a “drawers” menu. These methods will be particularly useful for apps (e.g. application software) running on touchscreen equipped computerized devices. However in other embodiments, these methods may also be used in non-touchscreen equipped computerized devices, and may also be used for other forms of software such as websites displayed in web browsers, and the like.

In this disclosure the term “computerized device” generally comprises devices (e.g. laptop computers, desktop computers, tablet computers, smartphones, and the like) that contain at least one computer processor (e.g. a microprocessor), memory, usually a network interface, an operating system, and a graphical user interface. The graphical user interface will generally comprise a bit-mapped display screen capable of displaying text and images, and user interface devices such as touchscreens or touchpads, and optionally keyboards, mice, voice input, video input, and the like.

The sliding side menu, which will usually be displayed on the graphical user interface of the computerized device, will generally comprise a plurality of text or icon labeled menu items, often arranged in various rows of at least one column. At least some of these menu items will often further comprise links (e.g. touch activated links) to other app screens or webpages.

Typically, by touching or clicking on these links, the app will then jump to the corresponding app page, screen, webpage, and the like.

The invention's sliding side menu will generally be configured to open and close upon user touch input (or alternatively mouse input) to the computerized device touchscreen display or other display screen.

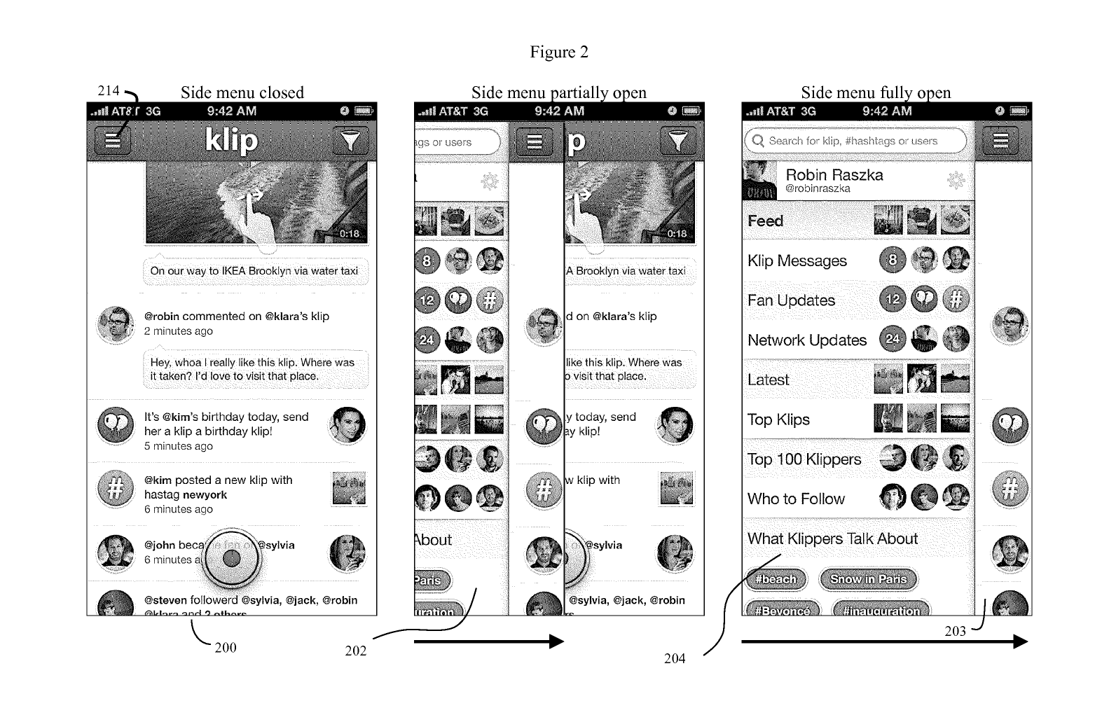

As previously discussed, often the software that generates such sliding side menus will be configured so that the menu gradually opens and shuts over the course of a few seconds or fractions of a second. Among other aspects, this sliding feature helps the user remember the context in which the sliding side menu is being used. An example of a sliding side menu in operation, showing such a gradual extension process, is shown in FIG. 2, and this will be discussed in more detail shortly.

Often at least some of the updateable content that is displayed on the sliding side menu items may represent updated screens or webpages. These updated screens or webpages in turn may be new or updated text, new or updated images, new or updated video and the like. Such new or updated text, images, or video can be provided by many alternative sources. It may, for example, be automatically generated by the computerized device itself, or by a remote server. Often, however, the new or updated text, images, or video will be generated by the human operators of various other computerized devices. These other human operators may, for example generate new content by uploading new text (e.g. various comments or articles), new images, new video and the like.

The links between the various sliding side menu items and various updateable screens or webpages may be predetermined by the app software or other software. Alternatively, in order to more flexibly link the various sliding side menu items to various updatable screens or webpages, or other updatable data of interest, during a prior configuration stage, either at the user's particular computerized device, or on a remote server, the user may configure the sliding side menu with particular links of interest.

Alternatively the device or a remote server may provide such links automatically (e.g. as a default standard settings). As an example of such automatic menu configuration, a social network user may, through following certain individuals of interest, and in combination with computerized device software or remote server software, automatically authorize the software to create various links between various sliding side menu items, and various updatable screens or webpages associated with the individuals of interest being followed by the user.

Typically, the computerized device software, configured according to the method, and optionally in conjunction with server software also configured according to the method, will use it's least one computer processor to monitor the status of at least some of those menu items that were previously linked to updateable screens or webpages. The software will also often generate a status change message (or other type of change message) when at least one of these updateable screens or webpages are updated. Alternatively the remote server may do all of the monitoring, and push the updates to the computerized device.

Thus the invention's methods may be implemented by only the computerized device software itself. Here the device, for example, may analyze data downloaded one or more feeds from one or more conventional servers. The device will detect changes in screens or webpages associated with updated content, and automatically configure the sliding side screen menus, indicia, and links accordingly.

Alternatively, and as previously described, the monitoring for updated content can be done entirely on the remote server, and changes simply pushed to the computerized device.

In still other embodiments, the invention will utilize both computerized device software (e.g. app software) configured according to the invention, as well as remote server software also configured according to the invention. In these embodiments, remote servers, which will usually have access to very large numbers of incoming data feeds (and often have much greater computing capability than the processor(s) on a particular computerized device), do most or all of the monitoring work because these remote servers are generally in a better position to monitor large amounts of data for updates or other changes. These remote servers can, in turn, transmit these updates or changes to various computerized devices. The computerized devices can, in turn use the invention's methods to provide indicia of these various changes, and links to these various changes, on various menu items of sliding side menus. As needed, the computerized devices can also supplement any remote server monitoring with their own local change monitoring processes.

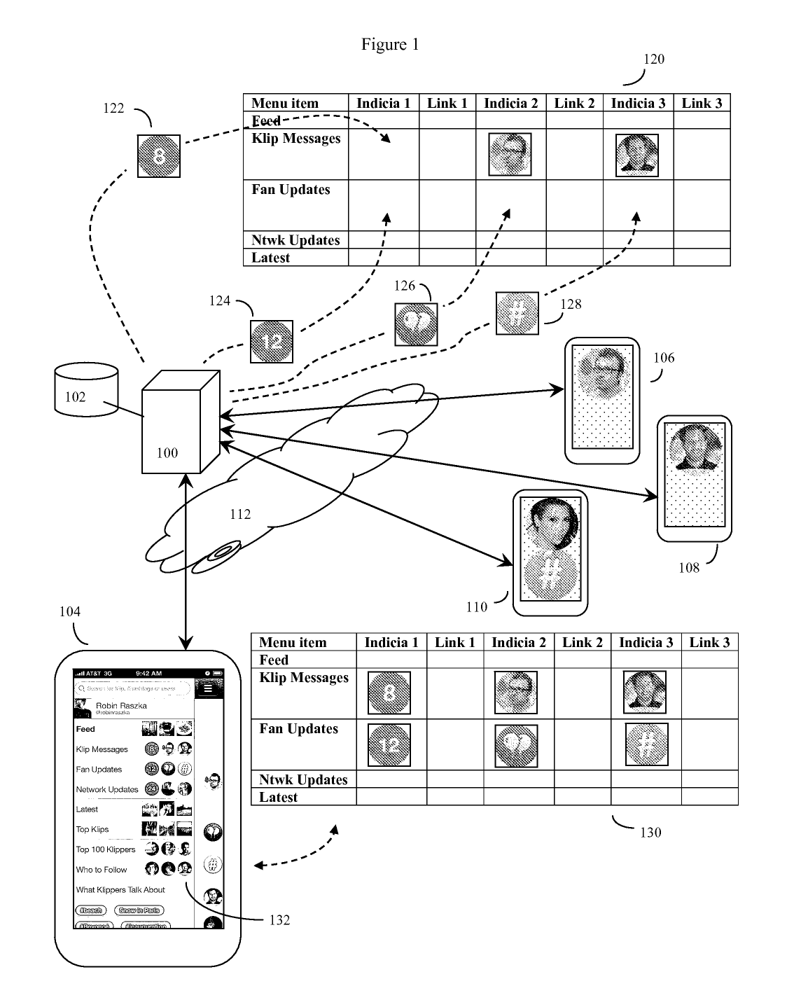

FIG. 1 shows an overview of one embodiment of how the invention's software implemented methods may operate. The invention's methods may operate with Internet server or other computer server (100), database (102) (e.g. mass storage memory connected to server (100) along with suitable database software such as MySQL) and various network connected computerized devices (104), (106), (108), (119) (here smartphones or tablet computers). The devices may communicate over a computer network such as the Internet (112).

In this example, the operator of device (104) is following, perhaps in an online social network type system, two friends who operate devices (106) and (108). The user is also a fan of a celebrity, who in turn is operating device (110). The devices all communicate information over the internet (112), often by one or more wireless Internet network interfaces (e.g. Wi-Fi, cellular network wireless 3G or 4G connections, etc.), via server (100). In this example, assume that the operators of devices (106, 108, and 110) have previously uploaded headshots of themselves (circled images) inside the devices.

In this example, also assume that the operator of device (104) has previously configured device (104) and/or server (100) to follow updates from the operators of devices (106), (108), (110). As a result (often by default software settings as previously described), the device and/or server side software controlling the sliding side menu items has been configured to identify when updates from the operators of devices (106), (108), (110) were made. These will be shown on the sliding side menu of an app running on device (104).

Further assume that in this situation, the owners of devices (106), (108), and (110) previously configured either the server (100) or server database (102) with indicia in the form of icons that represent an image (e.g. thumbnail version of the headshots) of the owners, here shown as the small headshots inside of devices (106), (108), and (110) respectively. In some embodiments, these indicia icons may be retransmitted each time the owner of device (106), (108), (110) transmits new relevant updates to server (100). Often, however, some or all of these indicia icons may have been previously uploaded to server memory (102), and can simply be linked to any new content by server (100). As yet another alternative, these indicia icons may be fully or partially preloaded into the memory of device (104).

In one embodiment, this server (100), often in a form that is customized for each user (104), can then assemble the various indicia of updated content, and links to updated content, in server memory. This process is visualized as table (120). The process of assembling and correlating markers of updated content with corresponding indicia and links is shown as steps (122), (124), (126) and (128).

As one type useful updated content indicia, the server (100) may count the number of new incoming messages from various sources. This number may represent, for example, the number of new messages received (122) since the user of device (104) either last opened their sliding side menu, or since the user of device last viewed their new message screen or page.

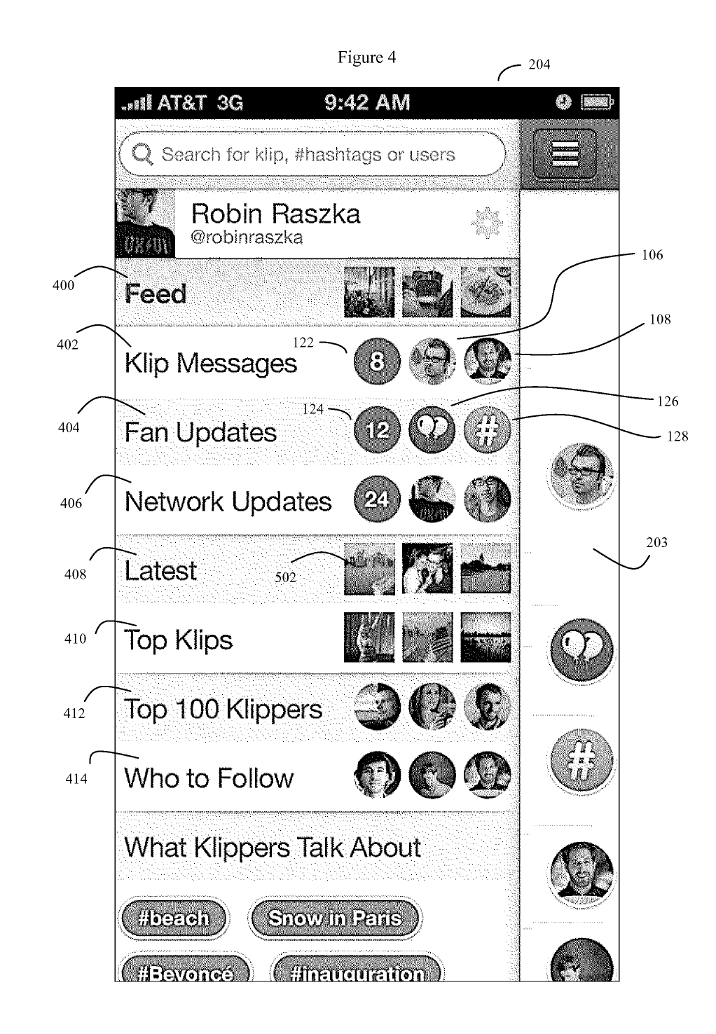

The number of new messages (in this example 8 (122) may be used to update table (120) indicia 1 for the menu item for “new messages”. See also FIG. 4(402).

As another example, shown in FIG. 1 (124) the server (100) may also count updates regarding celebrities (e.g. fan updates) as different menu item (see FIG. 4, (404)). In this example, there may have been 12 new updates for celebrities that user (104) is following, and thus the table (120) indicia 1 for “Fan updates” may be given an indicia icon of (12).

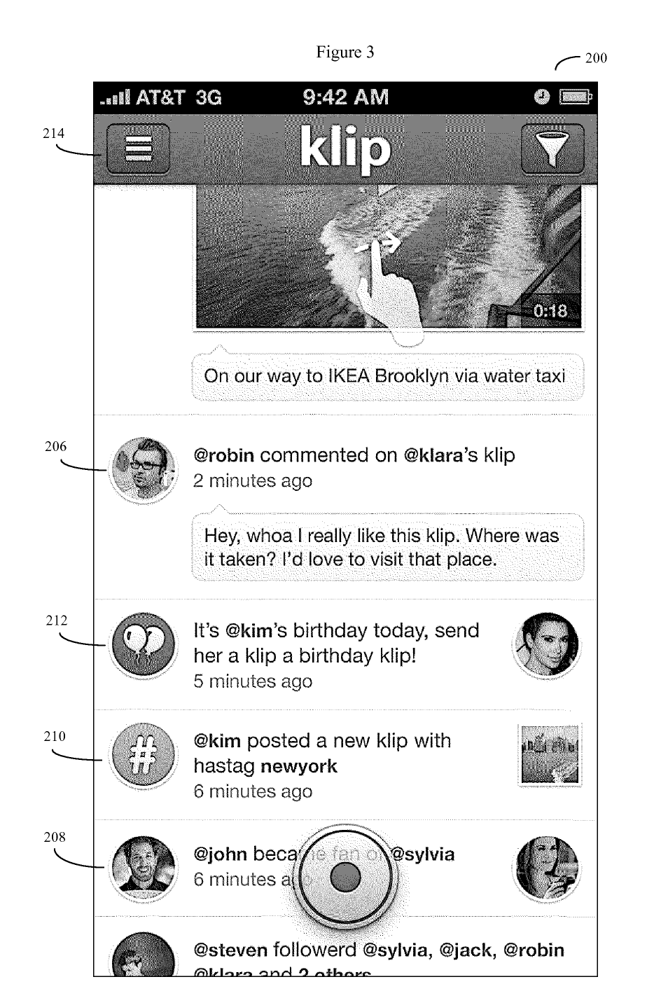

In this example, assume further that server (100), also knows that today is celebrity (110)'s birthday. If the server is configured to automatically send out reminders on this occasion, then this reminder may itself be scored as a new content update. If this automatically generated celebrity birthday announcement is the most recent update under menu item “fan updates”, then server may populate menu item “fan updates” table (120) indicia 2 with an icon of balloons (126) to indicate this celebrities birthday, as well as provide a link to this new and automatically generated birthday announcement. See also FIG. 3 (212), and FIGS. 4 (404) and (124).

In this example, also assume that celebrity (110), just before the automatically generated birthday content was provided by server (100), had also uploaded a new video clip under the hashtag “newyork”. If the server (100) is automatically programmed to show hashtag labeled communications with a (#) (pound) symbol, then if the operator of device (104) is a fan of celebrity (110), her communication may be labeled with a (#) indicia or icon (128) in the menu item “fan updates” table (120) indicia 3 section of memory. These various indicia or icons will also have their associated links. Here, because the links would have text too small to be seen on the illustrations, the link boxes are generally left blank.

Also in this example, for simplicity, assume that the communications from friends (106) and (108) of device user (104) were previously associated by server (100) with the appropriate headshot icons in the appropriate indicia locations by a similar process as above.

In this server implemented example, the assembled information stored in server memory, such as table (120), may then be transmitted by server (100) over the internet (112) to device (104) memory. There the information may be held in device (104)'s memory. Here this is represented as table (130). Once the information is properly stored in device (104) memory, the information may in turn be used by invention software running on device (104)'s memory to produce a sliding side menu (134, 204, 202) when the user triggers (e.g. by a swiping action, or by pressing an appropriate icon) the sliding side menu (134, 204, 202) to appear.

Note that all of the operations described as happening on server (100) can, in alternative embodiments, also be performed on device (104), although perhaps with lower speed or monitoring capability. Alternatively server (100) can provide a completely or nearly completely formatted sliding side menu page directly to device (104), in which case the software onboard device (104) need merely reproduce these server formatted menu pages.

In some embodiments, some or all of the updated content (e.g. updatable screens or webpages), or at least some of the information that was directly or indirectly included in some of the updatable screens or webpages, can also be hosted by remote server (100). In other embodiments, this updated content can be distributed thought a plurality of servers (not shown), and server (100) or device (104) can actively poll these other servers or devices for content, much like a search engine.

In other embodiments, the invention's software, running on device (104) and/or server (100), or both, can monitor the status of the updateable screens or webpages or other data, such as data generated by devices (106), (108), (110) or even internally by server (100) itself. The invention's software may also detect, and transmit to device (104), status changes when at least one of these updateable screens or webpages or other new content data are updated. This can be done by, for example, using at least one push message from the remote internet web server (100). Alternatively, device (104) may initiate at least on one pull request to remote internet server (100) or other computer server.

Such a pull request can be done, for example, by having device (104) first send a query message to server (100) inquiring about recent status changes (e.g. new content). If server (100) detects such status changes, then it may in turn transmit information pertaining to these status changes back to device (104). Alternatively the server can transmit a message that status changes have been detected, and then the device (104) can request more detailed information in a subsequent message to server (100).

In this embodiment, at device (104), the invention's software, often running on an app which in turn often runs on top of an operating system (e.g. iOS, Android, Windows, Linux, and the like) can, for at least some of those menu items linked to updated screens or webpages, use these status change messages to in turn select or choose indicia (e.g. corresponding headshots from 106, 108, or icons 122-128), and display indicia of these one or more updates. These indicia will usually be displayed in corresponding sliding side menu item rows (see FIG. 4) and as previously discussed, the indicia may optionally also contain an embedded, touch activated, or other type link to these various updated screens, webpages, text, images, or video. Alternatively the entire sliding side menu item row may itself contain a single touch or click activated link to a single screen, app page, or web page that contains the update information reported by that column's various indicia.

As previously discussed, often the indicia comprise either an icon representing the person or organization that updated the updated screens or webpages or other data (e.g headshots such as those associated with 106 and 108), or an icon representing the type of update action (e.g. the birthday icon 126, or the hashtag icon 128, or icons 122 or 124) performed by the person, device, or organization that updated these updated screens, webpages or other type information.

In some embodiments, it will be useful to display more than one (e.g. a plurality) of indicia on at least some of these menu items linked to updated screens or webpages. Indeed, many of the examples provided here, which were formatted for the relatively small iPhone 5 display screen, show three such indicia.

These various indicia can, for example, represent either the most recent change messages from the various updated screens, webpages or other data. Alternatively the various indicia can be the most important change messages according to an importance algorithm. Essentially any update selection and ranking scheme may be used here. Often it is useful to present the indicia in reverse chronological order, so that information pertaining to the latest update is seen first by a standard human reader of English or other common language who reads in a left to right type eye movement pattern.

The net result of the invention is that it thus allows a human user of the computerized device, such as device (104) to visually see indicia of at least some updated screens or webpages on the various sliding side menu items when the sliding side menu is open.

FIG. 2 shows an example of the invention's improved sliding side menu in operation. Here on the left (200), the user is first viewing the original app page, which here is scrolling new message feed that shows various messages, announcements, and video clips as these arrive. New messages start at the top, and are gradually pushed down to the bottom and then off the screen as they are displaced by still newer messages.

In the middle of FIG. 2, the user has invoked the sliding side menu (202) (perhaps by pressing icon 214), and this sliding side menu is shown partially extended over the original app page. On the right, the sliding side menu (204) has fully extended, and now covers most of the original app page (note that this is the same page previously shown in FIG. 1 (132)). Only a small stub of the original app page remains (203), which is useful to help the user retain a memory of the original app page (200) in the user's human short term memory.

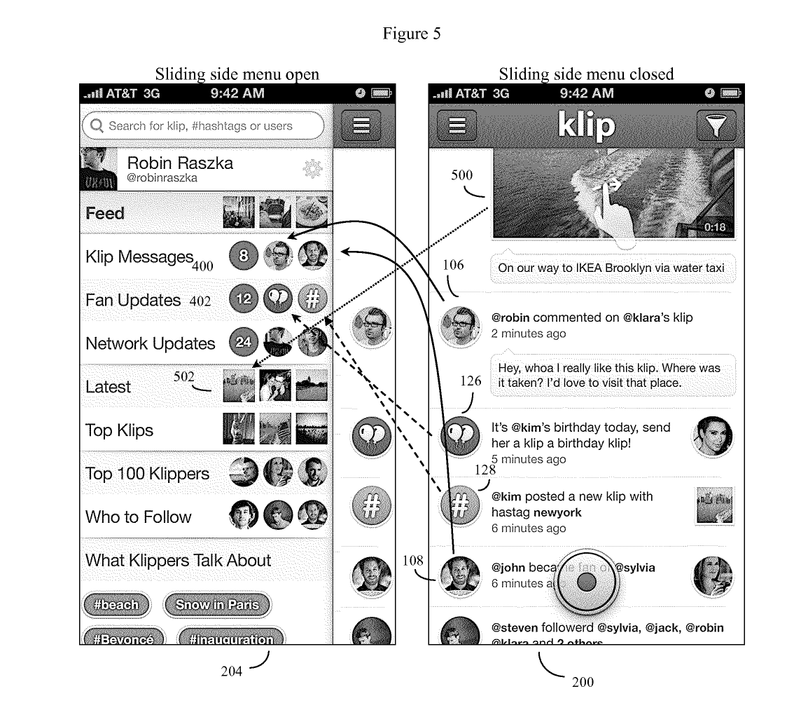

This sliding side menu (204/132) shows various menu items, at least some of which are linked to indicia (here small icons) showing various types of updated content. Indeed some of the most recently updated content, also seen on the original app screen on the left, is also reflected in some of the sliding side menu indicia icons. This correspondence is shown in more detail in FIG. 5.

FIG. 3 shows a larger view of the original app page (200), showing a scrolling set of update messages from various individuals that the app user is following. This page also shows an automatically server generated celebrity update as well. All of these updates were received within the last few minutes. For example, the update from the device operated by user (106) is shown as (206), the update from the device operated by user (108) is shown as (208), and the update from the device operated by celebrity (110) is shown as (210). Additionally, the automated birthday announcement for celebrity (110) provided by server (100) is shown as (212).

In this example, as previously discussed, the user may trigger the appearance of the sliding menu (204/132) by pressing on the menu icon (214) on the touch sensitive screen of device (104).

FIG. 4 shows a larger view of the invention's improved sliding side menu. This shows various sliding side menu items, such as the menu items for “Klip Messages” (402) and “Fan Updates” (404), as well as other menu items, in more detail.

Examples of other sliding side menu items can include:

Feed (row 400)—this can be a list of actions taken by people in the user's social graph, such as friend X posted a video, friend Y followed friend Z, friend T commented on U's video, and so on. For example, this can be indicia (icons) showing thumbnail images of the last 3 to 6 videos in the feed to or from server (100).

Latest (row 408)—this can be a global list of all videos being posted to server (100). For example, this can be indicia (icons) showing thumbnail images of the latest videos posted to server (100).

Top klips (row 410)—this can be a list of the most popular 100 klips, based on a trending real-time algorithm or other algorithm, either in the order of increasing popularity, decreasing popularity, fastest growth rate, or other algorithm. For example, this can be thumbnail images of the last 3-6 videos that were ranked as top videos.

Klip messages (row 402)—this can be a list of one-on-one messages sent by other users of server (100), often in anti-chronological order (e.g. latest is listed first). For example, this can show thumbnail versions of the profile photos of the people who last sent a message (viewable by the user) to server (100).

Fan updates (row 404)—this can be a list of activities taken by people in the user's graph that the user is a fan of (e.g. movie stars, other famous people). For example, this can either be indicia icons showing things that the celebrity did, things associated with the celebrity, or alternatively thumbnail images of the celebrities profile photo, again usually presented in anti-chronological (e.g. last goes first) order.

Network updates (row 406)—this can be a list of activities that impact the user directly, such as person X followed the user, person Y commented on the user's video, person Z liked the user's video, and so on. For example, this can be indicia icons showing thumbnail versions of profile photos of the last 2 to 6 people that performed actions that impacted the user directly.

Top 100 klippers (row 412)—this menu item, which is focused on the users of the website Klip.com, can be a list of those top 100 users of server (100) who, in this example, submitted the most popular video clips (here the users are called “klippers”, and the video clips are called “klips”). The order presented can be based on a trending algorithm, for example as ranked by decreasing popularity order, where the person who has submitted the most popular video is presented first. This can be indicia icons showing thumbnail versions of the profile photos of the last three to six people who were added to the top users (top klippers) list.

Who to follow (row 414)—this can be a list of server (100) suggested people to follow, which in turn can be based on various types of social algorithms. For example, this can be indicia icons showing thumbnail versions of the profile photos of the top 3 to 6 people in a “who to follow list”. Such a list can be generated by various methods, including by popularity, randomly, using a round-robin algorithm, and so on.

Other functions (not shown) can include menu items such as “Find Friend”, which might be a list of friends of the user who are already registered on server (100). For example this might show indicia icons showing thumbnail versions of the profile photos of 3 to 6 friends of the user, here again chosen by various methods including by popularity, randomly, using a round-robin algorithm, and so on.

Although the events can be presented in either chronological order, anti-chronological order, or other ranking, often an anti-chronological order, in which the latest update is presented first, is often most preferable to users.

In FIG. 4, note further that the Klip Messages menu item row (402) has indicia icons associated with (122, 106, 108), as previously discussed. Similarly the “Fan Updates” menu item row (404) has indicia icons associated with (124, 126, 128) also previously discussed. Other menu items, such as Feed row (404) contain other types of indicia (e.g. images from recently updated videos, and the like) that are associated with other types of updated content.

FIG. 5 shows by connecting lines how, in this example, at least some of the recent messages, announcements, and updates on the original app page are related to the corresponding indicia and links on the sliding side menu. In this example, a recently uploaded video clip (klip) (500) also has its own indicia in the form of a thumbnail image from the video in a corresponding “Latest” sliding menu item row (502). See also FIG. 4 row (408).

Various types of importance algorithm can be used to determine which updates have indicia placed on any given menu item, along with the order in which the update is placed on the menu item. In some embodiments, such as social network type embodiments, the degree of friendship or other measure of social closeness (e.g. social degrees of separation) or social connection with the person making the update may be used to determine the priority in which indicia of that person's update activity are placed on the menu item. In other embodiments, the user (or the system, perhaps as part of a default setting) may select the type of update or the identity of person that is to be given relatively higher or lower priority.

In other embodiments, an importance algorithm can determine if indicia of an update should be displayed on a menu item of a sliding side menu, and if so in what order it should appear. This can be done by ranking the importance of the update event according to a user selected type of action setting.

In some embodiments, the invention's software may monitor the status of various potentially updateable screens or webpages or other new content, and generate a status change when at least one of these potentially updateable screens or webpages are updated. This monitoring process may be by various methods. It may be done continuously in the background, or to save resources may only be done when the user opens or closes the sliding side menu. Alternatively, the monitoring process may be done on a repetitive basis (e.g. every portion of a second to every few seconds) while the sliding side menus are open. This later method would have the advantage of providing essentially “live” or “real-time” updates while the user is watching the sliding side menu.

Although, in many of the examples given here, the indicia icons often are based on an image that represents the person responsible for the updates, this need not always be the case. In other embodiments, the indicia can alternatively or additionally comprise text representing the person or organization responsible for the update, or text, images, or icons representing the update content. The indicia may also be text, images, or icons representing the type of update action performed by the person or organization that updated these updated screens or webpages. Here, for example, the birthday balloons icon (126) can represent a type of update action (e.g. a birthday type update). By contrast, the hashtag icon (128) can represent the content of the update (since here the update content includes a hashtag). Similarly, indicia icons that are thumbnail images of a recently submitted video or image can also be viewed as representing the content of the update.

1. A method of displaying indicia of updated content in at least one sliding side menu for a touchscreen computerized device graphical user interface;
said sliding side menu comprising a plurality of text or icon labeled menu items, at least some of said menu items further comprising links to other screens or webpages, said sliding side menu configured to open and close upon user touch input to said touchscreen, said method comprising:
for at least some of those menu items linked to updateable screens or webpages or other content, using at least one computer processor to monitor the status of said updateable screens or webpages or other content, and generating a change message when at least one of said updateable screens or webpages or other content are updated;
for at least some of those menu items linked to updated screens or webpages or other content, using said change message to choose indicia of said update, and displaying said indicia of said update on said menu items linked to updated screens or webpages or other content;
thus allowing a human user of said touchscreen computerized device to visually see indicia of at least some updated screens or webpages or other content on said menu items when said sliding side menu is open.

2. The method of claim 1, wherein said indicia comprise either an icon representing the person or organization that caused said screens or webpages or other content to be updated, or an icon representing the entity or entities that were affected by the update, or an icon representing the type of update action performed by the person or organization that caused said screens or webpages or other content to be updated.

3. The method of claim 2, wherein said screens or webpages or other content were updated by a person;
wherein said icon representing the person that caused said screens or webpages or other content to be updated is an image of said person.

4. The method of claim 2, further displaying a plurality of indicia on at least some of said menu items linked to updated screens or webpages or other content, said plurality of indicia representing either the most recent change messages from said updated screens or webpages or other content, or the most important change messages according to an importance algorithm.

5. The method of claim 4, wherein said importance algorithm ranks importance according to a measure of social closeness between the user and said person that caused said updated screens or webpages or other content to be update.

6. The method of claim 4, wherein said importance algorithm ranks importance according to a user selected type of update setting.

7. The method of claim 1, wherein said indicia comprise either text representing the person or organization that caused said updated screens or webpages or other content to be updated, or text representing the entity or intities that were affected by the update, or text representing the type of update action performed by the person or organization that updated said updated screens or webpages or other content.

8. The method of claim 1, wherein monitoring the status of said updateable screens or webpages or other content and generating a status change when at least one of said updateable screens or webpages or other content are updated, is done upon either opening or closing of said sliding side menu.

9. The method of claim 1, wherein monitoring the status of said updateable screens or webpages or other content and generating a status change when at least one of said updateable screens or webpages or other content are updated is done on a repetitive basis while said sliding side menus are open.

10. The method of claim 1, wherein at least some information included in some of said updateable screens or webpages or other content is hosted by a remote computer server.

11. The method of claim 10, wherein monitoring the status of said updateable screens or webpages or other content, and generating a status change when at least one of said updateable screens or webpages or other content are updated, is done by using at least one push message from said remote computer server.

12. The method of claim 10, wherein monitoring the status of said updateable screens or webpages or other content, and generating a status change when at least one of said updateable screens or webpages or other content are updated, is done by using said computerized device to initiate at least one pull request to said remote computer server.

13. A method of displaying indicia of updated content in at least one sliding side menu for an app running on a touchscreen computerized device graphical user interface or for a web site displayed on a browser running on a touchscreen computerized device with a graphical user interface;
said sliding side menu comprising a plurality of text or icon labeled menu items, at least some of said menu items further comprising links to other screens or webpages or other content, said sliding side menu configured to open and close upon user touch input to said touchscreen, said method comprising:
for at least some of those menu items linked to updateable screens or webpages or other content, using at least one computer processor to monitor the status of said updateable screens or webpages or other content, and generating a change message when at least one of said updateable screens or webpages or other content are updated;
wherein at least some of said information included in updateable screens or webpages or other content are hosted by a remote computer server;
wherein monitoring the status of said updateable screens or webpages or other content, and generating a change when at least one of said updateable screens or webpages or other content are updated, is done by using at least one push message from said remote internet server, or using at least one pull request to said remote computer server;
for at least some of those menu items linked to updated screens or webpages or other content, using said change message to choose indicia of said update, and displaying said indicia of said update on said menu items linked to updated screens or webpages or other content;
wherein said indicia comprise either an icon representing the person or organization that caused said screens or webpages or other content to be updated, or an icon representing the entity or entities that were affected by the update, or an icon representing the type of update action performed by the person or organization that caused said screens or webpages or other content to be updated;
further displaying a plurality of indicia on at least some of said menu items linked to updated screens or webpages or other content, said plurality of indicia representing either the most recent change messages from said updates screens or webpages or other content, or the most important change messages according to an importance algorithm;
thus allowing a human user of said touchscreen computerized device to visually see indicia of at least some updated screens or webpages or other content on said menu items when said sliding side menu is open.

14. The method of claim 13, wherein said importance algorithm ranks importance according to a measure of social closeness between the user and said person that caused said screens or webpages or other content to be updated; or
wherein said importance algorithm ranks importance according to a user selected type of update setting;
or wherein said importance algorithm ranks importance according to a user selected type of action setting.

15. The method of claim 13, wherein monitoring the status of said updateable screens or webpages or other content and generating a change message when at least one of said updateable screens or webpages or other content are updated, is done upon either opening or closing of said sliding side menu; or
wherein monitoring the status of said updateable screens or webpages or other content and generating a change message when at least one of said updateable screens or webpages or other content are updated is done on a repetitive basis while said sliding side menus are open.

16. The method of claim 13, wherein said indicia further comprise either text representing the person or organization that updated said caused said screens or webpages or other content to be updated, or test representing entity or entities that were affected by the update, or text representing the type of update action performed by the person or organization that caused said updated screens or webpages or other content to be updated.

17. The method of claim 13, wherein said icon representing the person that caused said screens or webpages or other content to be updated is an image representing the person that caused said screens or webpages or other content to be updated.
